(19) United States
(12) Patent Application Publication
(10) Pub. No.: US 2026/0162223 A1
(43) Pub. Date: Jun. 11, 2026

(54) IMAGE RESTORATION METHOD, COMPUTER DEVICE, AND STORAGE MEDIUM

(71) Applicant: TENCENT TECHNOLOGY (SHENZHEN) COMPANY LIMITED, Shenzhen (CN)

(72) Inventors: Xintao WANG, Shenzhen (CN); Liangbin XIE, Shenzhen (CN); Ying SHAN, Shenzhen (CN)

(21) Appl. No.: 19/062,214

(22) Filed: Feb. 25, 2025

Related U.S. Application Data
(63) Continuation of application No. PCT/CN2023/133919, filed on Nov. 24, 2023.

(30) Foreign Application Priority Data
Jan. 30, 2023 (CN) 202310092369.9

(51) Int. Cl. G06T 5/50; G06V 10/74; G06V 10/98

(52) U.S. Cl. CPC G06T 5/50; G06V 10/761; G06V 10/993

(57) ABSTRACT

An image restoration method includes restoring an input image using a first restoration model to provide a first restored image, the first restoration model being a model that restores image details and generates a defective region; restoring the input image using a second restoration model to provide a second restored image, the second restoration model being a model that achieves a lower degree of restoration of image details than the first restoration model and does not generate the defective region; based on the second restored image, identifying pixel points having defects in the first restored image to generate a mask map indicating locations of the pixel points having defects in the first restored image; and based on the mask map, replacing the pixel points having defects in the first restored image with pixel points in the second restored image to generate a reference restored image without having the defective region.

### CROSS-REFERENCES TO RELATED APPLICATIONS

This application is a continuation application of PCT Patent Application No. PCT/CN2023/133919, filed on Nov. 24, 2023 that claims priority to Chinese Patent Application No. 202310092369.9, filed on Jan. 30, 2023, all of which is incorporated herein by reference in their entirety.

### FIELD OF THE TECHNOLOGY

The present disclosure relates to the field of artificial intelligence and, in particular, to the field of image processing, and provides an image restoration method and apparatus, a computer device, a program product, and a storage medium.

### BACKGROUND OF THE DISCLOSURE

A typical manifestation of a degraded image includes blurs, distortion, and additional noise. As a result of degradation of the image, an image displayed at an image receiving end has been no longer an original image for transmission and an image display effect becomes significantly reduced. Therefore, it is necessary to process the degraded image to restore the true original image of the degraded image, and this process is called as image restoration.

The degraded image is usually processed by using a restoration model constructed based on a neural network to improve image quality. However, when the trained restoration model processes a new degraded image which has never been seen before, there will be a large range of significant defects in the outputted, restored image due to inexhaustible degrading conditions during a training process of the model, factors causing the image degradation, and poor model stability.

### SUMMARY

One embodiment of the present disclosure provides an image restoration method, performed by a computer device. The method includes: acquiring an input image; restoring the input image using a first restoration model to provide a first restored image, the first restoration model being a model that restores image details and generates a defective region; restoring the input image using a second restoration model to provide a second restored image, the second restoration model being a model that achieves a lower degree of restoration of image details than the first restoration model and does not generate the defective region; based on the second restored image, identifying pixel points having defects in the first restored image to generate a mask map that indicates locations of the pixel points having defects in the first restored image; and based on the mask map, replacing the pixel points having defects in the first restored image with pixel points in the second restored image to generate a reference restored image that does not comprise the defective region.

Another embodiment of the present disclosure provides a computer device. The computer device includes one or more processors and a memory containing a program code that, when being executed, causes the one or more processors to perform: acquiring an input image; restoring the input image using a first restoration model to provide a first restored image, the first restoration model being a model that restores image details and generates a defective region; restoring the input image using a second restoration model to provide a second restored image, the second restoration model being a model that achieves a lower degree of restoration of image details than the first restoration model and does not generate the defective region; based on the second restored image, identifying pixel points having defects in the first restored image to generate a mask map that indicates locations of the pixel points having defects in the first restored image; and based on the mask map, replacing the pixel points having defects in the first restored image with pixel points in the second restored image to generate a reference restored image that does not comprise the defective region.

Another embodiment of the present disclosure provides a non-transitory computer-readable storage medium containing a program code that, when being executed, causes a computer device to perform: acquiring an input image; restoring the input image using a first restoration model to provide a first restored image, the first restoration model being a model that restores image details and generates a defective region; restoring the input image using a second restoration model to provide a second restored image, the second restoration model being a model that achieves a lower degree of restoration of image details than the first restoration model and does not generate the defective region; based on the second restored image, identifying pixel points having defects in the first restored image to generate a mask map that indicates locations of the pixel points having defects in the first restored image; and based on the mask map, replacing the pixel points having defects in the first restored image with pixel points in the second restored image to generate a reference restored image that does not comprise the defective region.

### BRIEF DESCRIPTION OF THE DRAWINGS

The accompanying drawings described herein are configured for providing a further understanding of the present disclosure, and form part of the present disclosure. Schematic embodiments of the present disclosure and descriptions thereof are configured for explaining the present disclosure, and do not constitute any inappropriate limitation to the present disclosure. In the accompanying drawings:

FIG. 1A is a schematic diagram of a degraded image.

FIG. 1B is a schematic diagram of outputted restored images when degraded images of different types are restored.

FIG. 2A is an exemplary schematic diagram of an application scenario in an embodiment of the present disclosure.

FIG. 2B shows an image restoration method according to some embodiments of the present disclosure.

FIG. 3A is a schematic diagram of a flowchart of adjusting a restoration model based on a mask map provided in an embodiment of the present disclosure.

FIG. 3B is a schematic diagram of a logic of adjusting a restoration model based on a mask map provided in an embodiment of the present disclosure.

FIG. 3C is a schematic diagram of a flowchart of detecting defects of a first restored image provided in an embodiment of the present disclosure.

FIG. 3D is a schematic diagram of a logic of detecting defects of a first restored image provided in an embodiment of the present disclosure.

FIG. 3E is a schematic diagram of a logic of calculating a local texture feature of a pixel point a in a first restored image provided in an embodiment of the present disclosure.

FIG. 3F is a schematic diagram of a logic of calculating a relative texture difference between pixel points at the same location provided in an embodiment of the present disclosure.

FIG. 3G is a schematic diagram of a logic of calculating adjustment weights of a sky category and a building category provided in an embodiment of the present disclosure.

FIG. 4A is a schematic diagram of a flowchart of adjusting a restoration model based on a mask map provided in an embodiment of the present disclosure.

FIG. 4B is a schematic diagram of a logic of adjusting a restoration model based on a mask map provided in an embodiment of the present disclosure.

FIG. 5 is a schematic diagram of a logic of using a test image to fine-tune a GAN model provided in an embodiment of the present disclosure.

FIG. 6 is a schematic diagram of a structure of an image restoration apparatus provided in an embodiment of the present disclosure.

FIG. 7 is a schematic diagram of a hardware composition structure of a computer device applying an embodiment of the present disclosure.

FIG. 8 is a schematic diagram of a hardware composition structure of another computer device applying an embodiment of the present disclosure.

### DESCRIPTION OF EMBODIMENTS

To make the objectives, technical solutions, and advantages of the embodiments of the present disclosure more clear, the technical solutions of the present disclosure will be clearly and completely described below in conjunction with drawings in the embodiments of the present disclosure. It is clear that the described embodiments are merely a part of embodiments in the technical solutions of the present disclosure rather than all of the embodiments. Based on the embodiments recorded in the present disclosure document, all other embodiments obtained by a person of ordinary skill in the art without making creative efforts shall fall within the protection scope of the technical solutions of the present disclosure.

Part of terms in the embodiments of the present disclosure are explained and illustrated below to facilitate understanding of a person skilled in the art.

1. Artificial intelligence (AI):

Artificial intelligence involves a theory, a method, a technology, and an application system that use a digital computer or a machine controlled by the digital computer to simulate, extend, and expand human intelligence, perceive an environment, obtain knowledge, and use knowledge to obtain an optimal result. In other words, artificial intelligence is a comprehensive technology in computer science and attempts to understand the essence of intelligence and produce a new intelligent machine that can react in a manner similar to human intelligence. Artificial intelligence is to study the design principles and implementation methods of various intelligent machines, to enable the machines to have the functions of perception, reasoning, and decision-making.

The artificial intelligence technology is a comprehensive discipline, and relates to a wide range of fields including both hardware-level technologies and software-level technologies. The basic artificial intelligence technologies generally include technologies such as a sensor, a dedicated artificial intelligence chip, cloud computing, distributed storage, a big data processing technology, an operating/interaction system, and electromechanical integration. Artificial intelligence software technologies mainly include several major directions such as a computer vision technology, a speech processing technology, a natural language processing technology, and machine learning/deep learning.

With technical research and progress of artificial intelligence, artificial intelligence is studied and applied in many fields, for example, common smart home, smart customer service, virtual assistance, smart speakers, intelligent sales and marketing, unmanned driving, automatic driving, robots, and intelligent medical. It is believed that with the development of the technology, intelligent medical will be applied to more fields and play an increasingly important role.

2. Machine learning:

Machine learning is a multi-field inter-discipline, and relates to a plurality of disciplines such as probability theory, statistics, approximation theory, convex analysis, and algorithm complexity theory. Machine learning specializes in studying how a computer simulates or implements a human learning behavior to obtain new knowledge or skills, and reorganize an existing knowledge structure to keep improving the performance of the computer itself.

Machine learning is the core of artificial intelligence, is a basic way to make the computer intelligent, and is applied to various fields of artificial intelligence, including technologies such as deep learning, reinforcement learning, transfer learning, inductive learning, and teaching learning.

3. Computer vision is a comprehensive discipline integrating disciplines such as computer science, signal processing, physics, applied mathematics, statistics and nerve physiology and is also an important challenging research direction in the field of science.

This discipline replaces a visual organ with various imaging systems as an input means. A computer replaces a brain to complete processing and explaining, so that the computer may have the ability of observing and understanding the world visually like humankind. The subfield of the computer vision includes human face detection, human face comparison, five sense organs detection, blink detection, face anti-spoofing, and fatigue detection.

4. An MSE-SR model is a super-resolution model trained based on an MSE loss function. The super-resolution model may also be referred to as a restoration model. A GAN-SR model is a super-resolution model obtained by joint optimization of the MSE loss function and a GAN loss function.

5. Fine-tuning strategy: It often refers to a way to adjust a model parameter of a model by retraining the model.

In the present disclosure, it specially refers to the way to fine-tune the model parameter by slightly training a candidate restoration model.

The design solution of the embodiments of the present disclosure is described briefly below.

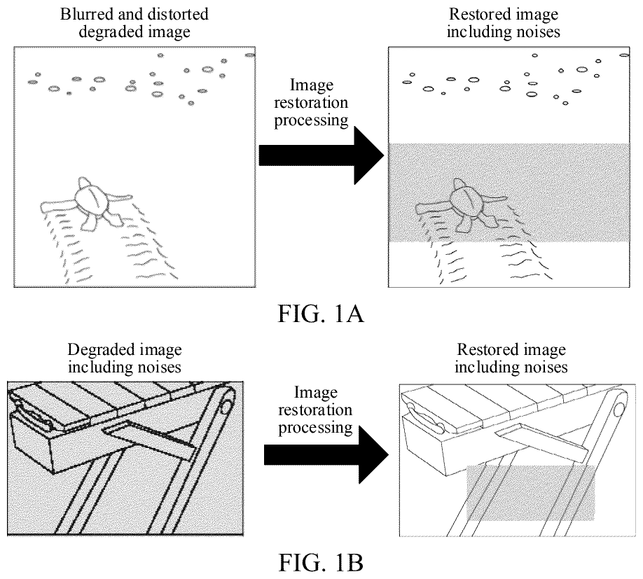

A typical manifestation of a degraded image includes blurs, distortion, and additional noise. In other words, the degraded image refers to an image with at least one of degradations such as blurs, distortion, and additional noise. As shown in FIG. 1A, an image sending end transmits a high-definition image showing a turtle climbing on a beach. As a result of degradation of the image, the image displayed at an image receiving end has been no longer the original image transmitted with a wide range of noise, and the visual effect of the image becomes significantly poor. Therefore, it is necessary to process the degraded image to restore the true original image of the degraded image, and this process is called as image restoration.

With the development of science and technology, the degraded image is usually processed by using a restoration model constructed based on a neural network, so that image quality is improved. However, due to inexhaustible degraded images during model training, many factors causing the image degradation, and poor model stability, when the trained restoration model processes a new degraded image which has never been seen before, there will be a large range of significant defects in the outputted restored image, for example, a large range of artifact regions. As shown in FIG. 1B, when a degraded image including noises is restored, there are still defects in the restored image outputted by the restoration model.

At present, to solve the problem that defects are generated in the restored image outputted by the model, the following two solutions are provided: A solution I is to introduce a gradient prediction branch to adjust the restoration model to eliminate the structural distortion in the restored image; and a solution II is to generate a probability graph for predicting that each pixel point in the restored image is a defective point and based on the probability graph, adjust the restoration model to achieve the purpose of inhibiting generation of defects.

However, since there are complicated and diversified factors that cause image degradation and it is hard to cover all types of degraded images in the training process, when processing a new degraded image, the restoration model adjusted based on the above solution will still output the restored image containing defects that affects the image quality.

Exemplary embodiments of the present disclosure are described below in conjunction with drawings of the specification. The exemplary embodiments described herein are merely configured for illustrating and explaining the present disclosure but are not intended to limit the present disclosure. The embodiments in the present disclosure and the features in the embodiments may be mutually combined without conflict.

The embodiments of the present disclosure may be applied to various scenarios, including, but not limited to cloud technology, artificial intelligence, intelligent transportation, and assisted driving.

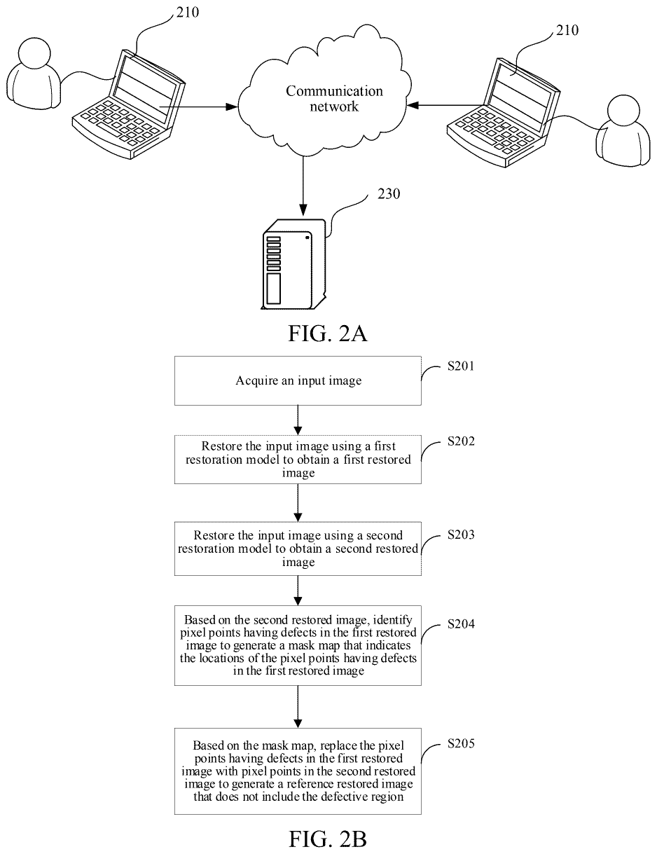

FIG. 2A shows one of the application scenarios, including two physical terminal devices 210 and one server 230. Each of the physical terminal devices 210 establishes a communication connection with the server 230 through a wired network or a wireless network.

The physical terminal device 210 in the embodiment of the present disclosure may be a smartphone, a tablet computer, a notebook computer, a desktop computer, a smart speaker, a smartwatch, and the like, but is not limited thereto.

The server 230 in the embodiment of the present disclosure may be an independent physical server, or may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform that is not limited herein.

A first restoration model deployed in the server 230 acquires a degraded image sent by the physical terminal device 210, and a first restoration model restores the degraded image to output a restored image.

FIG. 2B shows an image restoration method according to some embodiments of the present disclosure. The method is executed in a computer device.

As shown in FIG. 2B, S201: Acquire an input image. The degraded image herein is, for example, an input image with at least one of degradations such as blurs, distortion, and additional noise.

S202: Restore the input image using a first restoration model to obtain a first restored image. The first restoration model is a model that restores image details and generates a defective region. The first restoration model herein is, for example, a GAN-SR model. The GAN-SR model is a GAN-based restoration model, for example, a generator and a discriminator including a generative adversarial network. The first restoration model tends to restore image details and will amplify some defects (for example, unexpected high-frequency details in the input image) to generate the defective region, for example, an artifact region.

S203: Restore the input image using the second restoration model to obtain a second restored image. The second restoration model is a model that achieves a lower degree of restoration of image details than the first restoration model and does not generate the defective region. The second restoration model herein is, for example, an MSE-SR model and is also a GAN-based restoration model. Compared with the first restoration model, the second restoration model tends to smooth the input image and the degree of restoring the image details is lower than that of the first restoration model. Therefore, in an output result (for example, the second restored image), there will no defective regions in the output of the first restoration model.

S204: Based on the second restored image, identify pixel points having defects in the first restored image to generate a mask map that indicates locations of the pixel points having defects in the first restored image. For example, the pixel point with a value of 1 in the mask map indicates that the pixel points at the same location in the first restored image have defects, for example, the pixel points at the same location have the artifact. The pixel point with a value of 0 in the mask map indicates that the pixel points at the same location in the first restored image have no defects.

S205: Based on the mask map, replace the pixel points having defects in the first restored image with pixel points in the second restored image to generate a reference restored image not including the defective region. The reference restored image herein is an image obtained using a replacing operation in operation S205.

In conclusion, the image restoration method according to the embodiment of the present disclosure can determine the defective region in the first restored image using the second restored image according to characteristics of the first restored image (the degree of restoring the image details is higher but there may be the defective region) and characteristics of the second restored image (the degree of restoring the image details is lower than that in the first restored image but there may be no defective region) to replace the pixel points having defects in the first restored image with the pixel points in the second restored image, so that the defects of the first restored image can be compensated to obtain the reference restored image where the degree of restoring the image details is high and which eliminates the defective regions caused by the first restoration model to further improve the image restoration processing accuracy. In other words, the image restoration method in the embodiment of the present disclosure can improve the definition and resolution of the image restoration result.

In some embodiments, based on the reference restored image and the first restored image, a loss value associated with a model parameter of the first restoration model may also be determined in the embodiment of the present disclosure. The model parameter of the first restoration model is adjusted according to the loss value. When the first restoration model is used or a test image is used to test the first restoration model in an actual scenario, there is no ground truth in the input image (i.e., degraded image). In the present disclosure, the reference restored image may be regarded as a ground truth image. Based on this, the loss value of the first restoration model may be determined through the reference restored image and the output (i.e., the first restored image) of the first restoration model, so that the first restoration model which has been trained is subjected to fine-tuning, and therefore, the first restoration model can restore the image details and further can inhibit the defective regions to further improve the accuracy of restoring the image by the first restoration model and improve the definition and resolution of the restored image.

In addition, in the embodiment of the present disclosure, the parameters of the first restoration model may be adjusted through a few amount of input images (for example, test images), so that when the fine-tuned first restoration model processes the true degraded image including a similar degradation type, the fine-tuned first restoration model will inhibit defects which originally emerge on the restored image to a certain extent to finally output the restored image containing no defects or a small amount of defects, thereby effectively improving the image quality.

In some embodiments, operation S204 may include: identifying a similarity between pixel points in the first restored image and pixel points at the same locations in the second restored image; and generating, according to the similarity, the mask map that indicates locations of the pixel points having defects in the first restored image. The higher the similarity corresponding to one pixel point in the first restoration model herein is, the closer the pixel point to the pixel point at the same location in the second restored image is, and the lower the probability of defects is. Therefore, based on the similarity, the mask map may be determined.

In some embodiments, in order to identify the similarity, operation S204 may, based on respective local texture features of pixel points in the first restored image and pixel points at the same locations in the second restored image, determines a texture difference between the pixel points in the first restored image and the pixel points at the same locations in the second restored image. The local texture feature of one pixel point characterizes a texture complexity of a local region where the pixel point is located. The texture difference characterizes a texture difference between local regions. Further, the similarity may be determined according to the texture difference. The texture difference herein is inversely proportional to the similarity.

In an embodiment, the method in the embodiment of the present disclosure further includes: performing semantic segmentation on the first restored image to determine at least one semantic region included in the first restored image. A semantic segmentation operation herein may be performed by using various semantic segmentation modes that is not limited herein. Each semantic region corresponds to one semantic object. The type of the semantic object herein may be various objects emerging in the image, for example, objects such as figures, vehicles and building.

Further, an adjustment weight of each semantic region in the at least one semantic region may be acquired. The adjustment weight of each semantic region characterizes an awareness sensitivity of a human eye on defects in each semantic region. The adjustment weight of each semantic region is, for example, a preset value. For example, the same defective region (for example, the artifact) emerging in the semantic region with complex texture is hardly perceived by the human eye and the defective region emerging in the semantic region with simple texture is easily perceived by the human eye, i.e., the human eye has higher awareness sensitivity on the defects in the semantic region with complex texture. In short, in the semantic region with more complex texture, the defect is more hardly perceived. When the texture complexity in a semantic region is higher, the value of the adjustment weight is less.

Further, the similarity of pixel points in each semantic region may be adjusted according to the adjustment weight of each semantic region to obtain an adjusted similarity. For example, the greater the value of the adjustment weight of the semantic region is, the lower the degree of increasing the adjusted similarity is. On the contrary, the less the value of the adjustment weight of the semantic region is, the higher the degree of increasing the adjusted similarity is. The higher the degree of increasing the similarity herein is, the less the probability that the pixel point has defects is, so that in the semantic region with more complex texture, the detecting sensitivity to the defects is reduced, and therefore, the proportion of the pixel points replaced in the semantic region is reduced. Thus, the pixel points having defects hardly perceived by the human eye are filtered (i.e., the pixel points having defects hardly perceived by the human eye are reserved in the reference restored image), so that more image details are reserved in the reference restored image.

In some embodiments, the generating, according to the similarity, the mask map that indicates locations of the pixel points having defects in the first restored image includes:
comparing a similarity corresponding to each pixel point in the first restored image with a first preset threshold, where the first preset threshold is, for example, 0.7;
determining a pixel point with a similarity less than the first preset threshold as the pixel point having defects; and
generating the mask map according to the determined pixel point having defects.

In some embodiments, based on respective local texture features of pixel points in the first restored image and pixel points at the same locations in the second restored image, the determining a texture difference between the pixel points in the first restored image and the pixel points at the same locations in the second restored image includes:

for each pixel point in the first restored image, a local region taking each pixel point as a center is determined according to a preset size of the local region. The local region is, for example, an 11*11 region.

A standard difference of pixel points in the local region corresponding to each pixel point is determined as the local texture feature of each pixel point.

A difference value between the respective local texture features of the pixel points in the first restored image and the pixel points at the same location in the second restored image is calculated as an absolute texture difference between the pixel points.

Based on the respective local texture features of the pixel points in the first restored image and the pixel points at the same location in the second restored image and the corresponding absolute texture difference, a relative texture difference between the pixel points in the first restored image and the pixel points at the same location in the second restored image is determined as the texture difference between the pixel points in the first restored image and the pixel points at the same location in the second restored image. The relative texture difference is configured to characterize a texture difference independent of the texture complexity of the local regions between the local regions.

In some embodiments, the acquiring an adjustment weight of each semantic region in the at least one semantic region includes:
acquiring a plurality of images;
for each image in the plurality of degraded images, executing the following operations: respectively restoring each image using the first restoration model and the second restoration model to obtain a first restored image and a second restored image corresponding to each image; identifying a similarity between pixel points in the first restored image and pixel points at the same locations in the second restored image; and performing semantic segmentation on each image to obtain semantic regions of each image;
based on semantic categories of a plurality of semantic regions in the plurality of images, determining pixel points belonging to each of the semantic categories in a plurality of first restored images corresponding to the plurality of images;
dividing a preset value range of the similarity into a plurality of intervals arranged in a descending order;
determining, according to a similarity corresponding to pixel points belonging to each semantic category, intervals where corresponding pixel points are located;
determining, according to the interval where the pixel points are located, a proportion of the pixel points belonging to each semantic category in each interval;
for any semantic category, sequentially selecting a partition according to a sequence of the plurality of intervals and calculating an accumulated value of the proportion of the pixel points belonging to the semantic category in the selected partition till the accumulated value reaches a second preset threshold;
when the accumulated value reaches the second preset threshold, taking an end value of the currently selected partition as the adjustment weight of the corresponding semantic category; and
determining, according to the semantic category where each semantic region in the at least one semantic region belongs to and the adjustment weight of each semantic category, the adjustment weight to acquire each semantic region in the at least one semantic region.

In some embodiments, the image restoration method further includes: eroding the mask map to obtain the eroded mask map to filter the defective regions with a small area, i.e., filter the defective regions which are hardly perceived by the user without further replacing the pixel points of the filtered small defective regions.

In addition, the eroded mask map is expanded to obtain an expanded mask map. Thus, the disconnected defective regions may be connected as a larger defective region to further improve the recognition accuracy of the regions having defects.

In an embodiment, the eroding the mask map to obtain an eroded mask map includes: eliminating pixel points with defect areas in the mask map less than a third preset threshold and filling the eliminated pixel points. The expanding eroded mask map to obtain an expanded mask map includes: in the eroded mask map, connecting the pixel points having defects as at least one defective region to generate the expanded mask map.

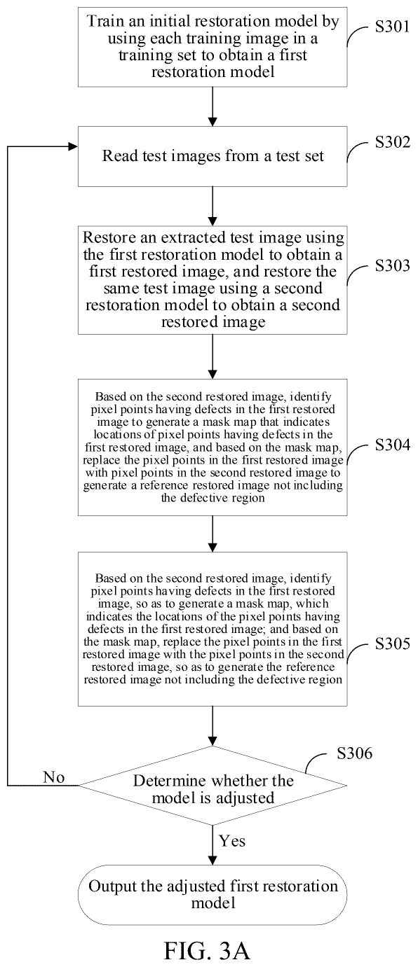

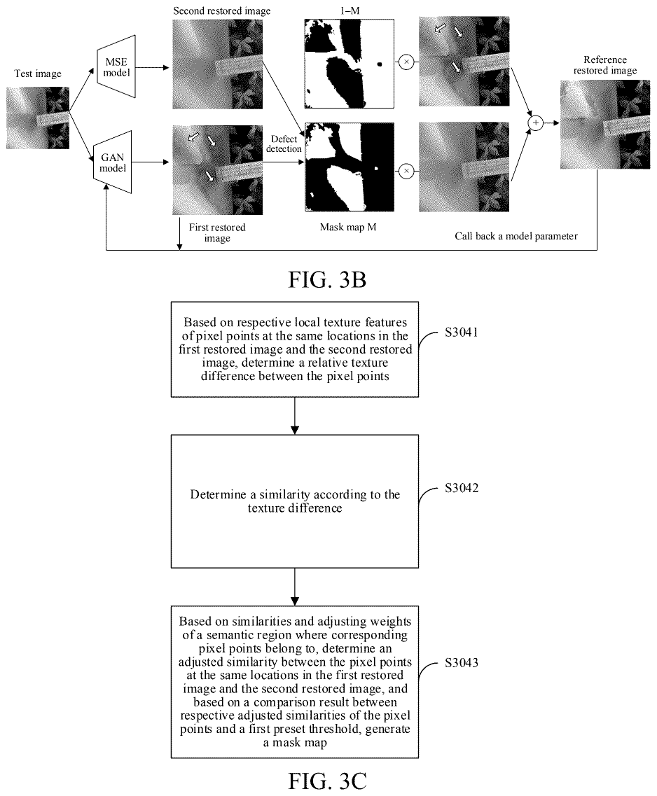

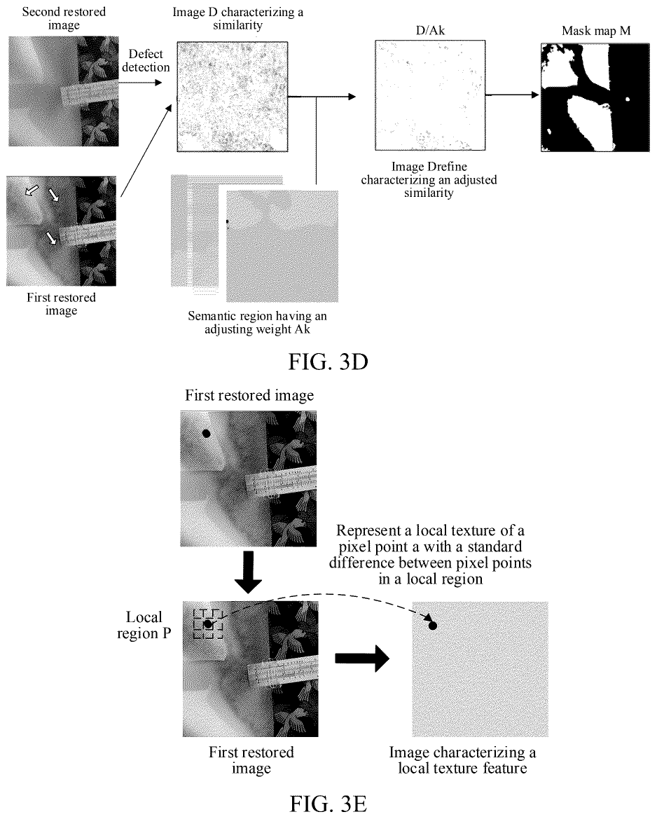

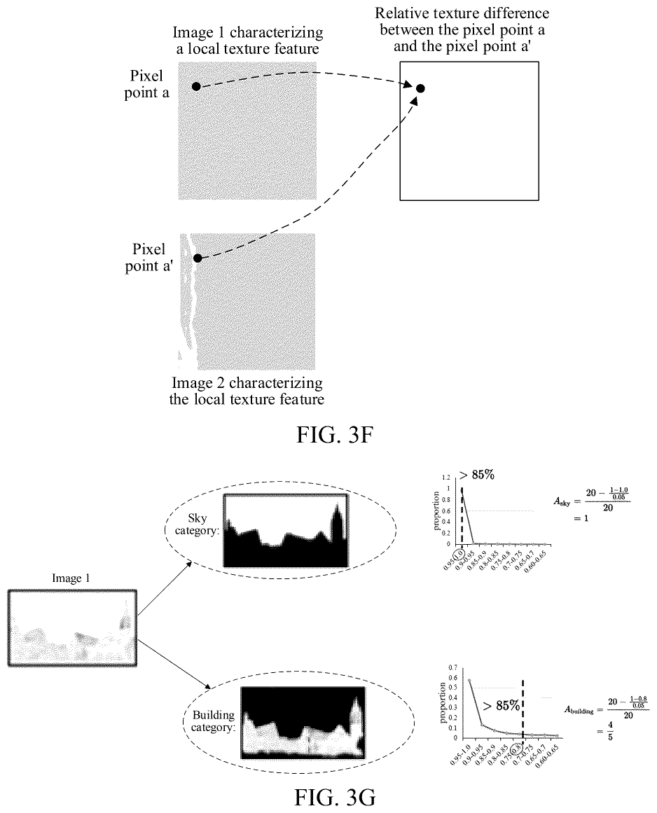

As shown in FIG. 3A-FIG. 3B, the process of iteratively adjusting the first restoration model many times to obtain the adjusted first restoration model is as follows:

S301: Train an initial restoration model by using each training image in a training set to obtain the first restoration model.

In a model training stage, in order to enable the initial restoration model to be trained to learn the features of the degraded image, the degraded image with blurs, distortion, additional noise and the like will be taken as the training image to iteratively train the initial restoration model many rounds to obtain the first restoration model.

However, since there are complicated and diversified factors that cause image degradation and it is hard to cover all types of degraded images in the training process, when a new degraded image which has never been seen is processed, there will be a wide range of significant defects in the restored image outputted by the restoration model. Therefore, it is necessary to execute the following operations to further optimize and adjust the first restoration model to reduce the problem that the restored image has defects.

S302: Read test images from a test set.

Although the test images and training images are essentially degraded images, there are still following distinction points therebetween:

1) The training images are from a constructed database, and each training image contains a pre-annotated actual image label. The test images are from a real scenario, and each test image does not include a pre-annotated actual image label.

2) The test images are degraded images which do not emerge in the training set. Therefore, degeneration factors of the test images and the training images may be the same or different, and based on each test image, model performance of the model may be tested when the model processes the new degraded image which has never been seen.

S303: Restore an extracted test image (i.e., the test image is taken as the input image) using the first restoration model to obtain a first restored image, and restore the same test image using a second restoration model to obtain a second restored image.

In a model testing stage, the first restoration model and the second restoration model (for example, MSE-SE model) restore the same test image respectively and output respective restored images (i.e., the first restored image and the second restored image). Model parameters of the two models are different. The first restoration model tends to perform sharpening processing on the test image and can restore the image details, but also expand the defects in the test image to generate a first restored image including a wide range of defects (i.e., the defective region). When restoring the test image, the second restoration model further tends to perform smoothing processing or fuzzy processing on the defects in the image to generate a second restored image not including the defective regions which will be imported by the first restoration model.

As shown in FIG. 3B, compared with blurred and distorted test images, the resolution of the first restored image is somewhat improved, the image details can be exhibited more clearly, but there are a wide range of significant defective regions, referring to the region indicated by the arrow in the first restored image for detail. Although the second restored image has no defective regions, the degree of restoring the image details is lower than that of the first restored image.

S304: based on the second restored image, identify pixel points having defects in the first restored image to generate a mask map that indicates locations of the pixel points having defects in the first restored image; and based on the mask map, replace the pixel points having defects in the first restored image with pixel points in the second restored image to generate a reference restored image not including the defective region.

As shown in FIG. 3C-FIG. 3D, the process of identifying the pixel points having defects in the first restored image to generate the mask map includes:

S3041: Based on the respective local texture features of the pixel points at the same locations in the first restored image and the second restored image, determine a relative texture difference between the pixel points.

First, the following operations are respectively executed for each pixel point of each restored image to determine the respective local texture feature of each pixel point to generate respective local texture images of each restored image: constructing a local region taking a pixel point as a center using a preset local sliding window, and then based on a distribution condition of the pixel points in the local region, determining the local texture feature of the pixel point.

As shown in FIG. 3E, based on the size of the local sliding window, a local region P taking a pixel point a as a center is constructed in the first restored image, respective pixel values of the pixel points in the local region are substituted into a formula 1 to calculate a standard difference between the pixel points, and the calculated standard difference is taken as the local texture feature of the pixel point a.

$$σ ( i , j ) = sd ( P ( i - \frac{n - 1}{2} : i + \frac{n - 1}{2} , j - \frac{n - 1}{2} : j + \frac{n - 1}{2} ) ) , \qquad Formula 1$$

where σ(i, j) represents the local texture feature of the pixel point a, and i and j are horizontal and vertical coordinates of the pixel point a. sd (·) represents a standard deviation

$$P ( i - \frac{n - 1}{2} : i + \frac{n - 1}{2} , j - \frac{n - 1}{2} : j + \frac{n - 1}{2} )$$

operation, represents the local region taking the pixel point a as the center, n is the size of the local sliding window, and the value of n may be customized according to an actual scenario requirement, for example 11.

As shown in FIG. 3F, the following operations are executed for the pixel points at the same locations in the first stored image and the second restored image to obtain the texture difference image: based on the difference value between the local texture feature of the pixel point a in the first restored image and the local texture feature of the pixel point a′ at the same location in the second restored image, determining the absolute texture difference between the pixel point a and the pixel point a′; and then, based on the absolute texture difference, the local texture feature of the pixel point a and the local texture feature of the pixel point a′, determining the relative texture difference between the pixel point a and the pixel point a′.

A specific implementation of the absolute texture difference between the pixel points refers to a formula 2; and a specific implementation of the relative texture difference between the pixel points refers to a formula 3.

$$d ( x , y ) = {( {σ}_{x} - {σ}_{y} )}^{2} ; and \qquad Formula 2$$

$${d}^{′} ( x , y ) = \frac{{( {σ}_{x} - {σ}_{y} )}^{2}}{2 {σ}_{x} {σ}_{y}} , \qquad Formula 3$$

where σₓ represents the standard difference of the corresponding pixel point a in the first restored image, σ_{y} represents the standard difference of the correspondingly pixel point a′ in the second restored image, d(x, y) represents the absolute texture difference between the pixel point a and the pixel point a′, and d′(x, y) represents the relative texture difference between the pixel point a and the pixel point a′ as the texture difference between the pixel points.

S3042: Determine the similarity according to the texture difference.

Specifically, the relative texture difference is normalized to an interval of [0,1] to generate an image characterizing the similarity. A specific implementation refers to a formula 4, d is the corresponding similarity of one pixel point in the image characterizing the similarity, and C is a constant.

$$d = \frac{1}{1 + \frac{{( {σ}_{x} - {σ}_{y} )}^{2}}{2 {σ}_{x} {σ}_{y}} + \frac{C}{2 {σ}_{x} {σ}_{y}}} = \frac{2 {σ}_{x} {σ}_{y}}{{σ}_{x}^{2} + {σ}_{y}^{2} + C} . \qquad Formula 4$$

S3043: Based on similarities and adjustment weights of a semantic region where corresponding pixel points belong to, determine an adjusted similarity between the pixel points at the same locations in the first restored image and the second restored image, and based on a comparison result between the adjusted similarities of the pixel points and a first preset threshold, generate a mask map.

In view of the defects emerging in different semantic regions by the human eye, the degrees of tolerance of the human eye are different. In the present disclosure, the pixel points having defects hardly perceived by the human eye are filtered by using the adjustment weight of each semantic region to generate a binarized mask map. For example, when the similarity corresponding to one pixel point of the mask map M is less than the first preset threshold, the pixel value is set as 1, indicating that the pixel point at the same location in the first restored image corresponding to the pixel point has defects. When the similarity corresponding to the pixel point is greater than or equal to the first preset threshold, the pixel value is set as 0, indicating that the pixel point does not correspond to the pixel point having defects.

First, for at least one semantic category, the following operations are executed respectively to obtain the adjustment weight of the corresponding semantic category:
acquiring a plurality of images, for example, images are acquired from a known data set;
for each image in the plurality of images, executing the following operations:
respectively restoring each image using the first restoration model and the second restoration model to obtain a first restored image and a second restored image corresponding to each image;
identifying a similarity d between pixel points in the first restored image and pixel points at the same locations in the second restored image; and
performing semantic segmentation on each image to obtain semantic regions of each image, each semantic region corresponding to one semantic category which is the category of the photographed object of the image;
based on semantic categories of a plurality of semantic regions in the plurality of images, determining pixel points belonging to each of the semantic categories in a plurality of first restored images corresponding to the plurality of images;
dividing a preset value range of the similarity into a plurality of intervals arranged in a descending order;
determining, according to a similarity corresponding to pixel points belonging to each semantic category, intervals where corresponding pixel points are located;
determining, according to the interval where the pixel points are located, a proportion of the pixel points belonging to each semantic category in each interval;
for any semantic category, sequentially selecting a partition according to a sequence of the plurality of intervals and calculating an accumulated value of the proportion of the pixel points belonging to the semantic category in the selected partition till the accumulated value reaches a second preset threshold; and
when the accumulated value reaches the second preset threshold, taking an end value of the currently selected partition as the adjustment weight of the corresponding semantic category.

A specific process of determining the adjustment weight of the semantic category for any semantic category is as follows:
according to a sequence from large to small, sequencing intervals divided by the value range (for example, a range from 0 to 1, including end points) of the similarity; and then reading (selecting) the proportions of the pixel points in the partition in sequence, where the following operations are executed once the proportion of the pixel points in each partition is read:
when it is determined that the current accumulated value meets the second preset threshold (for example, 0.85), based on an end value (for example, a left end value, i.e., a greater one in the two end values of the partition) of the currently read partition, determining the adjustment weight of the image category; and
when the current accumulated value reaches the second preset threshold, continuously reading a next partition.

Semantic segmentation is performed on an image shown in FIG. 3G to determine that the image includes two semantic categories: sky and building.

It is assumed that totally 1000 pixel points in the plurality of images belong to the sky category, where the similarities of 930 pixel points are in the partition (0.95,1.0] and the similarities of 70 pixel points are in the partition (0.9,0.95]. Therefore, the defect distribution proportion of the partition (0.95,1.0] is 0.93, the defect distribution proportion of the partition (0.9,0.95] is 0.07, and a line chart 1 is generated. x axis of the line chart 1 is a value range of the similarity value, and y axis is the proportion.

It is assumed that the second preset threshold is 0.85, the proportion of the pixel points in the partition (0.95,1.0] has exceeded the second preset threshold, the maximum value of the range of the partition (0.95,1.0] is 1.0, and as a parameter m in the formula 5, the adjustment weight of the sky category is calculated as 1.

It is assumed that totally 2000 pixel points in the plurality of images belong to the building category, where 1180 pixel points are in the partition (0.95,1.0], 260 pixel points are in the partition (0.9,0.95], 140 pixel points are in the partition (0.85,0.9], 120 pixel points are in the partition (0.8,0.85], 100 pixel points are in (0.75,0.8], 80 pixel points are in the partition (0.7,0.75], and 60 pixel points are in partitions of the partition (0.65,0.7] and the partition (0.6,0.65]. Therefore, the proportions of the pixel points corresponding to the partitions are successively as follows: 0.59, 0.13, 0.07, 0.06, 0.05, 0.04, 0.03, 0.03, and a line chart 2 is generated.

The accumulated values of the proportions in the partitions (0.95,1.0]-(0.75,0.8] exceed the second preset threshold 0.85, the maximum value of the partition (0.75,0.8] is 0.8 and is substituted into the formula 5 to calculate the adjustment weight of the building category as 0.8.

$${A}_{k} = \frac{20 - \frac{1 - m}{0.05}}{20} , \qquad Formula 5$$

where Aₖ is the adjustment weight. The ratio of the respective similarities of the pixel points in the semantic regions to the corresponding adjustment weight is taken as the adjusted similarity d_{refine}. A specific implementation refers to a formula 6.

$${d}_{refine} = \frac{d ( i , j )}{{A}_{k}} . \qquad Formula 6$$

For example, the pixel point a in a defect detection image belongs to the sky category, the adjustment weight of the sky category is 1, and the similarity of the pixel point a is 0.7. It may be known through calculation that the adjusted similarity of the pixel point a in the first restored image is 0.7.

The lower similarity means that the restoring degree between the pixel points at the same locations in the first restored image and the second restored image is more distant. Since the second restored image does not include the defective regions, for the pixel points with the similarity less than the first preset threshold in the first restored image, it is more possible that there are pixel points having defects. Therefore, the defects hardly perceived by the human eye are filtered and significant defects are reserved to obtain the mask map shown in FIG. 3D.

Since the test images are from a real scenario, each test image does not include a pre-annotated actual image label. In order to help the model to learn the features of the degraded image in the real scenario, operations S302-S304 are executed to generate the reference restored image without defects shown in FIG. 3B.

A specific implementation of, based on the mask map, replacing the pixel points having defects in the first restored image with pixel points in the second restored image to generate a reference restored image without defective regions refers to a formula 7. \tilde{y} represents the reference restored image, yGAN represents the first restored image, yMSE represents the second restored image, M represents the mask map, and (·) represents point-to-point multiplication.

$$\tilde{y} = M \cdot yMSE + ( 1 - M ) \cdot yGAN . \qquad Formula 7$$

S305: Based on the reference restored image and the first restored image, determine a loss value associated with a model parameter of the first restoration model.

S306: Adjust the model parameter of the first restoration model according to the loss value.

By using the fine-tuning strategy, the first restoration model is fine-tuned through a small amount of test images (i.e., input images), when the fine-tuned first restoration model processes the true degraded image including a similar degradation type, it will inhibit defective regions which originally emerge on the restored image to a certain extent to finally output the restored image containing no defects or a small amount of defects, thereby effectively improving the image quality.

S306: Determine whether the model is adjusted, and if yes, output the adjusted first restoration model; or, return to operation 302.

When meeting the at least one of the following, it is determined that the model is trained, and the first restoration model adjusted in this round is outputted; or, it is returned to operation 302, and a next round of iterative training is started:
(1) the loss value is less than or equal to a set loss value;
(2) the current iterative round reaches a set iterative round; and
(3) all test images in the test set have all been read.

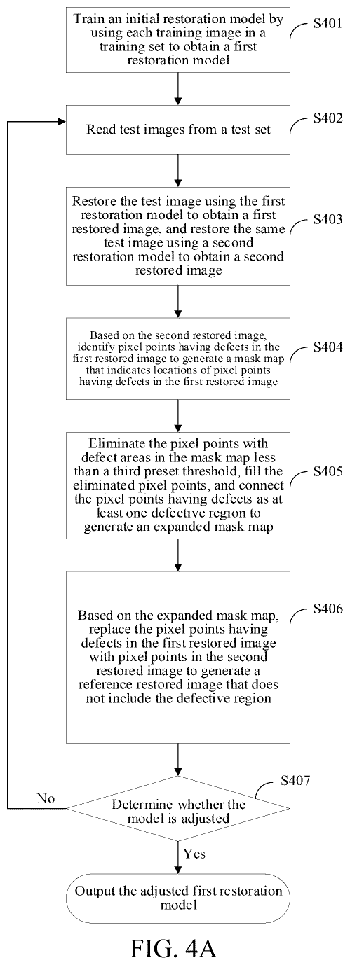

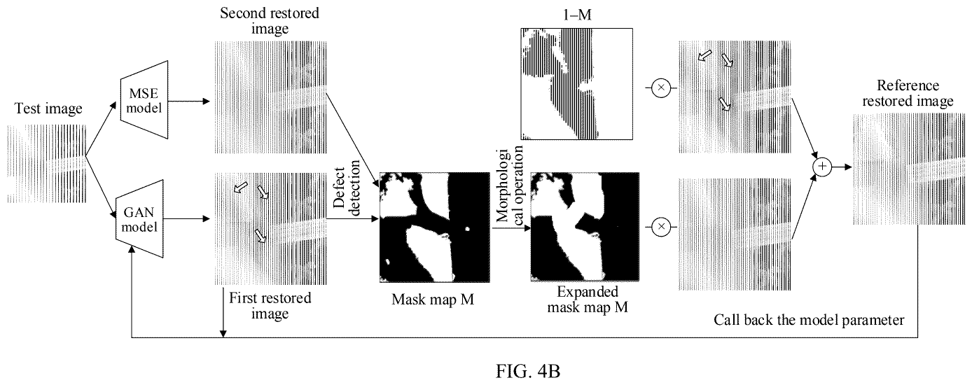

In the mask map shown in FIG. 3D, three defects with larger area and a plurality of defects with smaller area are included. In order to facilitate model learning, in the present disclosure, the mask map is subjected to a morphological operation to delete the defects with smaller area. The original plurality of defects with larger area are connected to an intact defective region to obtain a fourth restored image shown in FIG. 4B.

Next, referring to the schematic diagrams shown in FIG. 4A-FIG. 4B, the process of adjusting the first restoration model using the fourth restored image is as follows:

S401: Train an initial restoration model by using each training image in a training set to obtain the first restoration model.
S402: Read test images from a test set.
S403: Restore the test image using the first restoration model to obtain the first restored image, and restore the same test image using the second restoration model to obtain the second restored image.
S404: Based on the second restored image, identify the pixel points having defects in the first restored image to generate a mask map that indicates locations of the pixel points having defects in the first restored image.
S405: Eliminate pixel points with defect areas in the mask map less than a third preset threshold, fill the eliminated pixel points, and connect the pixel points having defects as at least one defective region to generate the expanded mask map.
S401-S404 and S301-S304 execute the same operations, and specific implementations are shown previously for detail that are not described repeatedly herein.

When operation S405 is executed, the mask map is eroded using an operator 1 to delete the pixel points with the defective area less than the third preset threshold in the image. Upon executing the eroding operation, there will be a plurality of void pixel points in the image, and these void pixel points are filled and fixed with pixel values using an operator 2 or are randomly filled with pixel values.

In order to connect the defects originally scattered everywhere in the image as one or more defective regions with larger area, the mask map is expanded using the operator 1, and the pixel points having defects are connected as at least one defective region to obtain an expanded mask map. The operator sizes of the operator 1 and the operator 2 are different.

S406: Based on the mask map, replace the pixel points having defects in the first restored image with pixel points in the second restored image to generate a reference restored image not including the defective region, and adjust the model parameter of the first restoration model using the loss value determined based on the reference restored image and the first restored image.

Since the test images are from a real scenario, each test image does not include a pre-annotated actual image label. In order to help the model to learn the features of the degraded image in the real scenario, operations S402-S406 are executed to generate the reference restored image without defect regions shown in FIG. 4B. A specific implementation refers to the formula 7 mentioned previously that is not described repeatedly herein.

S407: Determine whether the model is adjusted, and if yes, output the adjusted first restoration model; or, return to operation 402.

when meeting the at least one of the following, it is determined that the model is trained, and the first restoration model adjusted in this round is outputted; or, it is returned to operation 402, and a next round of iterative training is started:
(1) the loss value is less than or equal to a set loss value;
(2) the current iterative round reaches a set iterative round; and
(3) all test images in the test set have all been read.

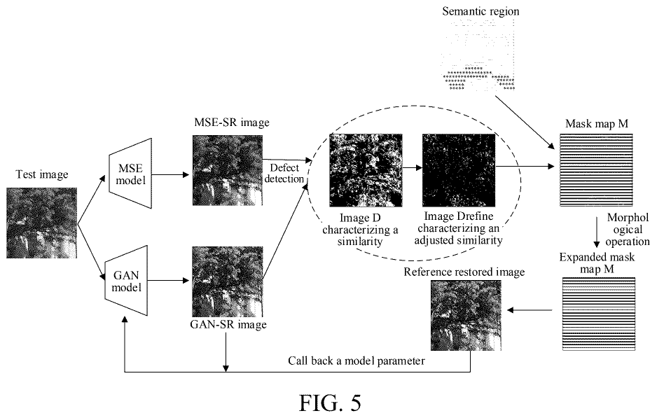

Taking the test image shown in FIG. 5 as an example, a process of using a test image to fine-tune a GAN model is introduced.

The test image shown in FIG. 5 is restored using the GAN model to obtain a GAN-SR image (i.e., the first restored image), and at the same time, the same test image is restored using the MSE model to obtain an MSE-SR image (i.e., the second restored image).

Defects of the GAN-SR image are detected using the MSE-SR image not including the defective region.

The semantic region in the first restored image has two semantic categories: tree and building, where the region labeled with * refers to the area where the building category is located, and the region not labeled with * represents the region where the tree category is located. Based on the respective similarities of the pixel points in the first restored image and the adjustment weights of the semantic category where the pixel points belong to, the adjusted similarity between the pixel points at the same locations in the GAN-SR restored image and the MSE-SR restored image is determined. The pixel points with the similarities not exceeding the first preset threshold are reserved, and defects (such as tree leaves) hardly perceived by the human eye are deleted to generate the mask map.

The mask map is subjected to the morphological operation to delete the defects with smaller area. The original plurality of defects with larger area are connected to an intact defective region to obtain an expanded mask map. Then, based on the expanded mask map, the pixel points having defects in the first restored image are replaced with pixel points in the second restored image to generate a reference restored image not including the defective region. In addition, the model parameter of the first restoration model is adjusted using the loss value determined based on the reference restored image and the first restored image.

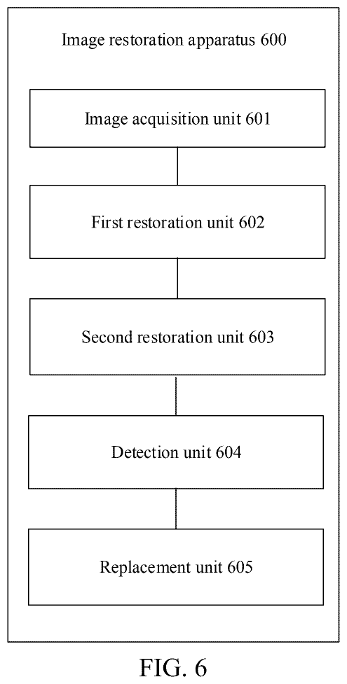

Based on the same inventive concept, an embodiment of the present disclosure further provides a restoration model adjusting apparatus. As shown in FIG. 6, the restoration model adjusting apparatus 600 may include:
an image acquisition unit 601, configured to acquire an input image;
a first restoration unit 602, configured to restore the input image using a first restoration model to obtain a first restored image, the first restoration model being a model that restores image details and generates a defective region;
a second restoration unit 603, configured to restore the input image using a second restoration model to obtain a second restored image, the second restoration model being a model that achieves a lower degree of restoration of image details than the first restoration model and does not generate the defective region;
a detection unit 604, configured to, based on the second restored image, identify pixel points having defects in the first restored image to generate a mask map that indicates locations of the pixel points having defects in the first restored image; and
a replacement unit 605, configured to, based on the mask map, replace the pixel points having defects in the first restored image with pixel points in the second restored image to generate a reference restored image not including the defective region. A more specific implementation of the adjusting apparatus 600 is identical to that of the image restoration method above that is not described repeatedly herein.

For ease of description, the above components are respectively described as they are divided into modules (or units) according to functions. Certainly, in implementation of the present disclosure, the functions of the modules (units) may be implemented in the same piece of or a plurality of pieces of software and/or hardware.

After the restoration model adjusting method and apparatus in the exemplary implementation of the present disclosure are introduced, next, a computer device in another exemplary implementation of the present disclosure will be introduced.

A person skilled in the art may understand that the aspects of the present disclosure may be implemented as systems, methods, or program products. Therefore, the aspects of the present disclosure may be specifically embodied in the following forms: hardware only implementations, software only implementations (including firmware and micro code), or implementations with a combination of software and hardware that are collectively referred to as “circuit”, “module”, or “system” herein.

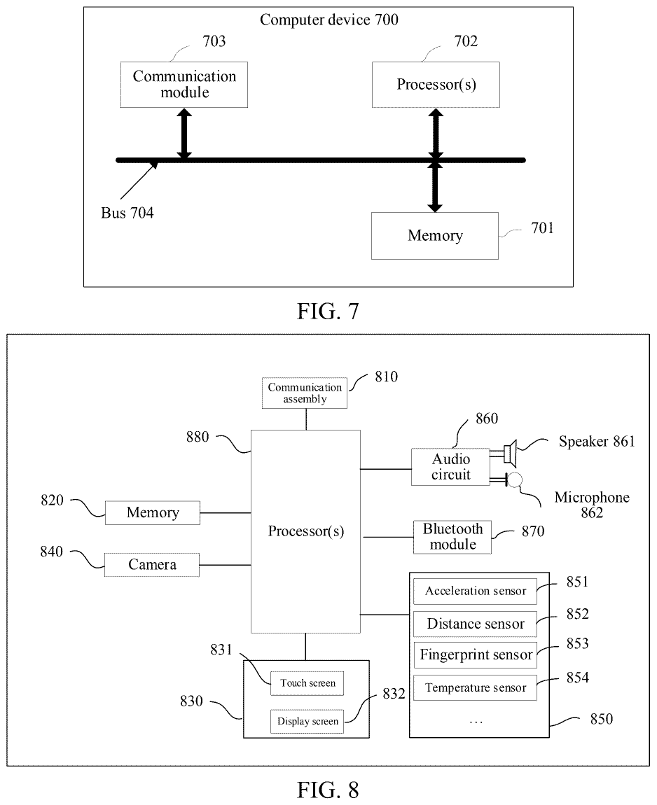

Based on the same inventive concept of the above method embodiment, an embodiment of the present disclosure further provides a computer device. In an embodiment, the computer device may be a server, a server 230 shown in FIG. 2. In the embodiment, the structure of the computer device 700 is shown in FIG. 7 and may at least include a memory 701, a communication module 703 and at least one processor 702.

The memory 701 is configured to store a computer program executed by the processor 702. The memory 701 may mainly include a program storage area and a data storage area, where the program storage area may store an operating system and a program to run an instant messaging function and the like; and the data storage area may store various instant messaging information and operating instruction sets and the like.

The memory 701 may be a volatile memory, for example, a random access memory (RAM); the memory 701 may also be a non-volatile memory, for example, a read-only memory, a flash memory, a hard disk drive (HDD) or a solid-state drive (SSD); or the memory 701 is any other medium capable of being configured to carry or store an expected computer program having an instruction or data structural form and being accessed by the computer that is not limited herein. The memory 701 may be a combination of the above memories.

The processor 702 may include one or more central processing units (CPU) or digital processing units. The processor 702 is configured to implement the restoration model adjusting method when calling the computer program stored in the memory 701.

The communication module 703 is configured to communicate with the terminal device or other servers.

Specific connecting media among the above memory 701, communication module 703 and processor 702 are not limited in the embodiment of the present disclosure. In the embodiment of the present disclosure, in FIG. 7, the memory 701 and the processor 702 are connected through a bus 704. The bus 704 is described by a thick line in FIG. 7. The connecting modes among other components are schematically illustrated only that are not limited herein. The bus 704 may be classified as an address bus, a data bus, a control bus, and the like. For ease of description, the bus is only described by a thick line in FIG. 7, but only a bus or a type of bus is not described.

The memory 701 has the computer storage medium stored, the computer storage medium has a computer executable instruction stored, and the computer executable instruction is configured to implement the restoration model adjusting method in the embodiment of the present disclosure. The processor 702 is configured to execute the above restoration model adjusting method, as shown in FIG. 3A.

In another embodiment, the computer device may also be another computer device, the physical terminal device 210 shown in FIG. 2. In the embodiment, the structure of the computer device may be shown in FIG. 8, including: components such as a communication assembly 810, a memory 820, a display unit 830, a camera 840, a sensor 850, an audio circuit 860, a Bluetooth module 870, and a processor 880.

The communication module 810 is configured to communicate with a server. In some embodiments, the structure of the electronic device may include a circuit wireless fidelity (WiFi) module, the WiFi module is a short distance wireless transmission technology, and the electronic device may help an object to transmit and receive information through the WiFi module.

The memory 820 may be configured to store a software program and data. The processor 880 executes various function functions of the physical terminal device 210 and processes data by running the software program or data stored in the memory 820. The memory 820 may include a high speed random access memory, and may alternatively include a non-volatile memory, such as at least one magnetic disk storage device, a flash memory, or another volatile solid-state storage device. The memory 820 stores an operating system causing the terminal device 210 to run. The memory 820 in the present disclosure may store the operating system and various application programs, and may further store a computer program that executes the restoration model adjusting method in the present disclosure.

The display unit 830 may further configured to display information inputted by the object or information provided to the object and graphical user interfaces (GUI) of various menus of the terminal device 210. Specifically, the display unit 830 may include a display screen 832 arranged on the front surface of the terminal device 210. The display screen 832 may be configured in the form of a liquid crystal display (LCD) and an organic light-Emitting diode (OLED), and the like. The display unit 830 may be configured to display a defect detection interface, a model training interface and the like in the embodiment of the present disclosure.

The display unit 830 may further be configured to receive inputted digit or character information and generate a signal input associated with object settings and function control of the physical terminal device 210. The display unit 830 may include a touch screen 831 arranged on the front surface of the terminal device 210, and the touch screen may collect touch operations on or near the object, for example, a click button and a dragging scroll box.

The touch screen 831 may cover the display screen 832 and the touch screen 831 and the display screen 832 may also be integrated to realize input and output functions of the physical terminal device 210. The integrated touch screen may be abbreviated as a touch display screen. The display unit 830 in the present disclosure may display the application program and corresponding operating operations.

The camera 840 may be configured to capture a static image, and the object may issue the image photographed by the camera 840 through the application. There may be one or more cameras 840. An optical image of a substance is generated through a lens and is projected to a photosensitive element. The photosensitive element may be a charge coupled device (CDD) or a complementary metal-oxide-semiconductor (CMOS) phototransistor. The photosensitive element converts an optical signal into an electrical signal and then transfers the electrical signal to the processor 880 to be converted into a digital image signal.

The physical terminal device may further include at least one sensor 850 such as an acceleration sensor 851, a distance sensor 852, a fingerprint sensor 853, and a temperature sensor 854. The terminal device may further be configured with other sensor(s) such as a gyroscope, a barometer, a hygrometer, a thermometer, an infrared sensor, an optical sensor, and a motion sensor.

The audio circuit 860, a speaker 861, and a microphone 862 may provide audio interfaces between the object and the terminal device 210. The audio circuit 860 may convert received audio data into an electric signal and transmit the electric signal to the speaker 861. The speaker 861 converts the electric signal into a sound signal and outputs the sound signal. The physical terminal device 210 may further be configured with a volume button, configured to adjust the volume of an acoustical signal. In another aspect, the microphone 862 converts a collected sound signal into an electric signal. The audio circuit 860 receives the electric signal, converts the electric signal into audio data, and then outputs the audio data to the communication assembly 810 to send the audio data to, for example, the other physical terminal device 210 or outputs the audio data to the memory 820 for further processing.

The Bluetooth module 870 is configured to perform information interaction with other Bluetooth devices having Bluetooth modules through a Bluetooth protocol. For example, the physical terminal device may establish a Bluetooth connection with a wearable electronic device (for example, a smartwatch) having a Bluetooth module through the Bluetooth module 870 to perform data interaction.

The processor 880 is a control center of the physical terminal device and configured to connect all parts of the entire terminal by using various interfaces and lines, and executes various functions of the terminal and processes data by running or executing the software program stored in the memory 820 and calling data stored in the memory 820. In some embodiments, the processor 880 may include one or more processing units; an application processor and a baseband processor may be integrated into the processor 880. The application processor mainly processes an operating system, a user interface, an application, and the like, and the baseband processor mainly processes wireless communication. The above baseband processor may either not be integrated into the processor 880. The processor 880 in the present disclosure may run the operating system and application programs, user interface display and touch response and the restoration model adjusting method in the embodiment of the present disclosure. In addition, the processor 880 is coupled with the display unit 830.

In addition, in the specific implementation of the present disclosure, relevant object data such as test image collection is involved. When the above embodiments of the present disclosure are applied to a specific product or technology, a permission or consent of an object is required, and collection, use, and processing of the relevant data need to comply with relevant laws, regulations, and standards of relevant countries and regions.

In some embodiments, aspects of the restoration model adjusting method provided in the present disclosure may further be realized in the form of a program product that includes a computer program. When the program product runs on the computer device, the computer program is configured to cause the computer device to execute operations in the restoration model adjusting method according to various exemplary implementations of the present disclosure described above in this specification, for example, the computer device may execute operations shown in FIG. 3A.

The program product may be any combination of one or more readable mediums. The readable medium may be a readable signal medium or a computer-readable storage medium. The readable storage medium may be, for example, but is not limited to, an electric, magnetic, optical, electromagnetic, infrared, or semi-conductive system, apparatus, or device, or any combination thereof. More specific examples of the readable storage medium (nonexhaustive list) include: an electrical connection having one or more wires, a portable disk, a hard disk, a random access memory (RAM), a read only memory (ROM), an erasable programmable ROM (EPROM or a flash memory), an optical fiber, a compact disc ROM (CD-ROM), an optical storage device, a magnetic storage device, or any suitable combination thereof.

The program product in the implementations of the present disclosure may use a compact disc read-only memory (CD-ROM), includes a computer program, and may be run on an electronic device. However, the program product in the present disclosure is not limited thereto. In this document, the readable storage medium may be any tangible medium including or storing a program, and the program may be used by or used in combination with a command execution system, an apparatus, or a device.

The readable signal medium may include a data signal being in a baseband or transmitted as a part of a carrier that carries the readable computer program. A data signal propagated in such a way may assume a plurality of forms, including, but not limited to, an electromagnetic signal, an optical signal, or any suitable combination thereof. The readable signal medium may alternatively be any readable medium other than a readable storage medium, and the readable storage medium may be configured to send, propagate, or transmit a program used by or in combination with an instruction execution system, apparatus, or device.

The computer program included in the computer-readable medium may be transmitted by using any suitable medium, including but not limited to: a wireless medium, a wire, an optical cable, an RF, and the like, or any suitable combination thereof.

The program code used for executing the operations of the present disclosure may be written by using any combination of one or more programming languages. The programming languages include an object-oriented programming language such as Java and C++, and also include a suitable procedural programming language such as “C” or similar programming languages. The program code may be completely executed on a user computer device, partially executed on the user computer device, executed as an independent software package, partially executed on a user computer device and partially executed on a remote computer device, or completely executed on a remote computer device. In cases involving a remote computer device, the remote computer device may be connected to a user computer device through any type of network including a local area network (LAN) or a wide area network (WAN), or may be connected to an external computer device (for example, through the Internet by using an Internet service provider).

Although several units or subunits of an apparatus are mentioned in the above detailed descriptions, the division is merely exemplary rather than mandatory. Actually, according to the implementations of the present disclosure, the features and functions of two or more units described above may be specifically implemented in one unit. On the contrary, the features and functions of one unit described above may be further divided to be embodied by a plurality of units.

In addition, although the operations of the method in the present disclosure are described in a specific order in the accompanying drawings, this does not require or imply that the operations are bound to be executed in the specific order, or all the operations shown are bound to be executed to achieve the expected result. Additionally or alternatively, some operations may be omitted, a plurality of operations may be combined into one operation for execution, and/or one operation may be decomposed into a plurality of operations for execution.

A person skilled in the art can understand that the embodiments of the present disclosure may be provided as a method, a system, or a computer program product. Therefore, the present disclosure may use a form of hardware-only embodiments, software-only embodiments, or embodiments combining software and hardware. Moreover, the present disclosure may use a form of a computer program product that is implemented on one or more computer-usable storage media (including but not limited to a disk memory, a CD-ROM, and an optical memory) that include a computer-usable computer program.

The present disclosure is described with reference to flowcharts and/or block diagrams of the method, the device (system), and the computer program product according to the embodiments of the present disclosure. Computer program instructions can implement each procedure and/or block in the flowcharts and/or block diagrams and a combination of procedures and/or blocks in the flowcharts and/or block diagrams. These computer program instructions may be provided to a general-purpose computer, a special-purpose computer, an embedded processor, or a processor of another programmable data processing device to generate a machine, so that an apparatus configured to implement functions specified in one or more procedures in the flowcharts and/or one or more blocks in the block diagrams is generated by using instructions executed by the computer or the processor of another programmable data processing device.

These computer program instructions may alternatively be stored in a computer-readable memory that can instruct a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

These computer program instructions may further be loaded onto a computer or another programmable data processing device, so that a series of operations and operations are performed on the computer or the another programmable device, thereby generating computer-implemented processing. Therefore, the instructions executed on the computer or the another programmable device provide operations for implementing a specific function in one or more processes in the flowcharts and/or in one or more blocks in the block diagrams.

In the embodiment of the present disclosure, the term “module” or “unit” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processor or memories) may be configured to realize one or more modules or units. In addition, each module or unit may be a part of an overall module or unit including the module or unit function.

Although exemplary embodiments of the present disclosure have been described, once persons skilled in the art know the basic creative concept, they can make additional changes and modifications to these embodiments. Therefore, the following claims are intended to be construed as to cover the exemplary embodiments and all changes and modifications falling within the scope of the present disclosure.

It is clear that a person skilled in the art can make various modifications and variations to the present disclosure without departing from the spirit and scope of the present disclosure. In this case, if the modifications and variations made to the present disclosure fall within the scope of the claims of the present disclosure and their equivalent technologies, the present disclosure is intended to include these modifications and variations.

What is claimed is:

1. An image restoration method, performed by a computer device, the method comprising:
acquiring an input image;
restoring the input image using a first restoration model to provide a first restored image, the first restoration model being a model that restores image details and generates a defective region;
restoring the input image using a second restoration model to provide a second restored image, the second restoration model being a model that achieves a lower degree of restoration of image details than the first restoration model and does not generate the defective region;
based on the second restored image, identifying pixel points having defects in the first restored image to generate a mask map that indicates locations of the pixel points having defects in the first restored image; and
based on the mask map, replacing the pixel points having defects in the first restored image with pixel points in the second restored image to generate a reference restored image that does not comprise the defective region.

2. The method according to claim 1, further comprising:
based on the reference restored image and the first restored image, determining a loss value associated with a model parameter of the first restoration model; and
adjusting the model parameter of the first restoration model according to the loss value.

3. The method according to claim 1, wherein identifying the pixel points having the defects in the first restored image comprises:
identifying a similarity between pixel points in the first restored image and pixel points at the same locations in the second restored image; and
generating, according to the similarity, the mask map that indicates locations of the pixel points having defects in the first restored image.

4. The method according to claim 3, wherein identifying the similarity between the pixel points in the first restored image and the pixel points at the same locations in the second restored image comprises:
based on respective local texture features of the pixel points in the first restored image and the pixel points at the same locations in the second restored image, determining a texture difference between the pixel points in the first restored image and the pixel points at the same locations in the second restored image, the local texture feature of a pixel point characterizing a texture complexity of a local region where the pixel point is located and the texture difference characterizing a texture difference between local regions; and
determining the similarity according to the texture difference.

5. The method according to claim 3, further comprising:
performing semantic segmentation on the first restored image to determine at least one semantic region comprised in the first restored image;
acquiring an adjustment weight of a semantic region in the at least one semantic region, the adjustment weight of the semantic region characterizing an awareness sensitivity of a human eye on defects in the semantic region; and
adjusting the similarity of pixel points in the semantic region according to the adjustment weight of the semantic region to obtain an adjusted similarity.

6. The method according to claim 3, wherein generating, according to the similarity, the mask map that indicates locations of the pixel points having the defects in the first restored image comprises:
comparing a similarity corresponding to a pixel point in the first restored image with a first preset threshold;
determining a pixel point with a similarity less than the first preset threshold as the pixel point having defects; and
generating the mask map according to the determined pixel point having defects.

7. The method according to claim 4, wherein determining the texture difference between the pixel points in the first restored image and the pixel points at the same locations in the second restored image comprises:
for a pixel point in the first restored image, determining, according to a preset size of the local region, a local region taking the pixel point as a center;
determining a standard difference of pixel points in the local region corresponding to the pixel point as the local texture feature of the pixel point;
calculating a difference value between the respective local texture features of the pixel points in the first restored image and the pixel points at the same location in the second restored image as an absolute texture difference between the pixel points; and
based on the respective local texture features of the pixel points in the first restored image and the pixel points at the same location in the second restored image and the corresponding absolute texture difference, determining a relative texture difference between the pixel points in the first restored image and the pixel points at the same location in the second restored image as the texture difference between the pixel points in the first restored image and the pixel points at the same location in the second restored image, the relative texture difference being configured for characterizing a texture difference independent of the texture complexity of the local regions between the local regions.

8. The method according to claim 5, wherein acquiring the adjustment weight of the semantic region in the at least one semantic region comprises:
acquiring a plurality of images;
for an image in the plurality of images, executing following operations:
respectively restoring an image using the first restoration model and the second restoration model to obtain a first restored image and a second restored image corresponding to the image;
identifying a similarity between pixel points in the first restored image and pixel points at the same locations in the second restored image; and
performing semantic segmentation on the image to obtain semantic regions of the image;
based on semantic categories of a plurality of semantic regions in the plurality of images, determining pixel points belonging to a semantic category in a plurality of first restored images corresponding to the plurality of images;
dividing a preset value range of the similarity into a plurality of intervals arranged in a descending order;
determining, according to a similarity corresponding to pixel points belonging to the semantic category, intervals where corresponding pixel points are located;
determining, according to the interval where the pixel points are located, a proportion of the pixel points belonging to the semantic category in an interval;
for any semantic category, sequentially selecting a partition according to a sequence of the plurality of intervals and calculating an accumulated value of the proportion of the pixel points belonging to the semantic category in the selected partition till the accumulated value reaches a second preset threshold;
when the accumulated value reaches the second preset threshold, taking an end value of the currently selected partition as the adjustment weight of the corresponding semantic category; and
determining, according to the semantic category where a semantic region in the at least one semantic region belongs to and the adjustment weight of the semantic category, the adjustment weight to acquire the semantic region in the at least one semantic region.

9. The method according to claim 1, further comprising:
eroding the mask map to obtain an eroded mask map; and
expanding the eroded mask map to obtain an expanded mask map.

10. The method according to claim 9, wherein eroding the mask map to obtain the eroded mask map comprises: eliminating pixel points with defect areas in the mask map less than a third preset threshold and filling the eliminated pixel points.

11. The method according to claim 9, wherein expanding the eroded mask map to obtain the expanded mask map comprises: in the eroded mask map, connecting the pixel points having defects as at least one defective region to generate the expanded mask map.

12. A computer device, comprising one or more processors and a memory containing a program code that, when being executed, causes the one or more processors to perform:
acquiring an input image;
restoring the input image using a first restoration model to provide a first restored image, the first restoration model being a model that restores image details and generates a defective region;
restoring the input image using a second restoration model to provide a second restored image, the second restoration model being a model that achieves a lower degree of restoration of image details than the first restoration model and does not generate the defective region;
based on the second restored image, identifying pixel points having defects in the first restored image to generate a mask map that indicates locations of the pixel points having defects in the first restored image; and
based on the mask map, replacing the pixel points having defects in the first restored image with pixel points in the second restored image to generate a reference restored image that does not comprise the defective region.

13. The device according to claim 12, wherein the one or more processors are further configured to perform:
based on the reference restored image and the first restored image, determining a loss value associated with a model parameter of the first restoration model; and
adjusting the model parameter of the first restoration model according to the loss value.

14. The device according to claim 12, wherein the one or more processors are further configured to perform:
identifying a similarity between pixel points in the first restored image and pixel points at the same locations in the second restored image; and
generating, according to the similarity, the mask map that indicates locations of the pixel points having defects in the first restored image.

15. The device according to claim 14, wherein the one or more processors are further configured to perform:
based on respective local texture features of the pixel points in the first restored image and the pixel points at the same locations in the second restored image, determining a texture difference between the pixel points in the first restored image and the pixel points at the same locations in the second restored image, the local texture feature of a pixel point characterizing a texture complexity of a local region where the pixel point is located and the texture difference characterizing a texture difference between local regions; and
determining the similarity according to the texture difference.

16. The device according to claim 14, wherein the one or more processors are further configured to perform:
performing semantic segmentation on the first restored image to determine at least one semantic region comprised in the first restored image;
acquiring an adjustment weight of a semantic region in the at least one semantic region, the adjustment weight of the semantic region characterizing an awareness sensitivity of a human eye on defects in the semantic region; and
adjusting the similarity of pixel points in the semantic region according to the adjustment weight of the semantic region to obtain an adjusted similarity.

17. The device according to claim 14, wherein the one or more processors are further configured to perform:
comparing a similarity corresponding to a pixel point in the first restored image with a first preset threshold;
determining a pixel point with a similarity less than the first preset threshold as the pixel point having defects; and
generating the mask map according to the determined pixel point having defects.

18. The device according to claim 15, wherein the one or more processors are further configured to perform:
for a pixel point in the first restored image, determining, according to a preset size of the local region, a local region taking the pixel point as a center;
determining a standard difference of pixel points in the local region corresponding to the pixel point as the local texture feature of the pixel point;
calculating a difference value between the respective local texture features of the pixel points in the first restored image and the pixel points at the same location in the second restored image as an absolute texture difference between the pixel points; and
based on the respective local texture features of the pixel points in the first restored image and the pixel points at the same location in the second restored image and the corresponding absolute texture difference, determining a relative texture difference between the pixel points in the first restored image and the pixel points at the same location in the second restored image as the texture difference between the pixel points in the first restored image and the pixel points at the same location in the second restored image, the relative texture difference being configured for characterizing a texture difference independent of the texture complexity of the local regions between the local regions.

19. The device according to claim 16, wherein the one or more processors are further configured to perform:
acquiring a plurality of images;
for an image in the plurality of images, executing following operations:
respectively restoring an image using the first restoration model and the second restoration model to obtain a first restored image and a second restored image corresponding to the image;
identifying a similarity between pixel points in the first restored image and pixel points at the same locations in the second restored image; and
performing semantic segmentation on the image to obtain semantic regions of the image;
based on semantic categories of a plurality of semantic regions in the plurality of images, determining pixel points belonging to a semantic category in a plurality of first restored images corresponding to the plurality of images;
dividing a preset value range of the similarity into a plurality of intervals arranged in a descending order;
determining, according to a similarity corresponding to pixel points belonging to the semantic category, intervals where corresponding pixel points are located;
determining, according to the interval where the pixel points are located, a proportion of the pixel points belonging to the semantic category in an interval;
for any semantic category, sequentially selecting a partition according to a sequence of the plurality of intervals and calculating an accumulated value of the proportion of the pixel points belonging to the semantic category in the selected partition till the accumulated value reaches a second preset threshold;
when the accumulated value reaches the second preset threshold, taking an end value of the currently selected partition as the adjustment weight of the corresponding semantic category; and
determining, according to the semantic category where a semantic region in the at least one semantic region belongs to and the adjustment weight of the semantic category, the adjustment weight to acquire the semantic region in the at least one semantic region.

20. A non-transitory computer-readable storage medium containing a program code that, when being executed, causes a computer device to perform:
acquiring an input image;
restoring the input image using a first restoration model to provide a first restored image, the first restoration model being a model that restores image details and generates a defective region;
restoring the input image using a second restoration model to provide a second restored image, the second restoration model being a model that achieves a lower degree of restoration of image details than the first restoration model and does not generate the defective region;
based on the second restored image, identifying pixel points having defects in the first restored image to generate a mask map that indicates locations of the pixel points having defects in the first restored image; and
based on the mask map, replacing the pixel points having defects in the first restored image with pixel points in the second restored image to generate a reference restored image that does not comprise the defective region.
